(19) United States
(12) Patent Application Publication
(10) Pub. No.: US 2011/0155806 A1
(43) Pub. Date: Jun. 30, 2011

(54) METHOD AND DATA CARRIER FOR STORING AND READING A DATA CODE

(76) Inventors: Thoralt Franz, Oelsnitz (DE); Sten Meinhold, Lugau (DE)

(21) Appl. No.: 12/666,544

(22) PCT Filed: May 6, 2008
(86) PCT No.: PCT/EP2008/055568

§ 371 Date: Jan. 11, 2011

(30) Foreign Application Priority Data
Jun. 26, 2007 (DE) 10 2007 029 384.6

(51) Int. Cl. G06K 7/06; G06K 19/077

(52) U.S. Cl. 235/435; 235/492

(57) ABSTRACT

Method and data carrier for storing and reading a data code, wherein at least two information tracks of electrically conductive material are printed onto a substrate in such a way that by parallel reading of the at least two information tracks a clock signal and a data signal are determined, by means of which the data code is formed. The clock signal is here formed by logic ORing of the information tracks and the data code is determined by interpreting the information tracks taking account of the clock signal.

The invention relates to a method and to a data carrier for storing a data code having a least two information tracks of electrically conductive material printed onto a substrate, the information tracks containing both a data signal and a clock signal.

EP-A-0 422 481 describes a method for capacitive read-out of two-dimensional conductive structures. In order to read the structures, however, a constant feed rate of the data carrier to be read is required. If the speed varies, this method is unable to read out the information reliably.

WO 06/108913 discloses a data carrier having two information tracks, one information track being a pure data signal and the other information track being a pure clock signal. The information track containing the data signal also comprises line sequences of different conductivity.

The invention now addresses the problem of improving the method and the data carrier for storing and reading a data code, having at least two information tracks of electrically conductive material printed onto a substrate, to the effect that the data code is reliably readable, even at an uneven feed rate of the substrate, for example, during manual insertion of a data carrier into a reading device, and yet a high storage capacity is provided.

That problem is solved according to the invention by the features of claims 1 and 8.

In the method according to the invention for storing and reading a data code, at least two information tracks of electrically conductive material are printed onto a substrate in such a way that by parallel reading of the at least two information tracks a clock signal and a data signal are determined, by means of which the data code is formed. The clock signal is here formed by logic ORing of the information tracks, and the data code is determined by interpreting the information tracks taking account of the clock signal.

The data carrier according to the invention for storing a data code comprises at least two information tracks of electrically conductive material printed onto a substrate, the information tracks containing both a data signal and a clock signal. The clock signal is in this case formed by logic ORing the information tracks, and the data code is defined by interpreting the information tracks taking account of the clock signal.

Whereas in the prior art according to WO 06/108913 an information track is provided only for the clock signal, according to the invention all the information tracks can be used for the data signal. In this way, with two information tracks, double the storage capacity is available.

Further embodiments of the invention are the subject matter of the subsidiary claims.

According to a preferred exemplary embodiment, the electrically conductive material comprises conductive polymers, in particular, PEDOT or PANI. The information tracks can here form, in particular, a line sequence.

According to an exemplary embodiment of the invention, the clock signal is formed by ORing the information tracks and interpolating any discontinuities, whereas the data code is determined by interpreting the information tracks taking account of the clock signal.

Because the information tracks contain a clock signal, the data code of the data carrier can be reliably determined even when the information tracks are read out at an uneven feed rate.

Further advantages and constructions of the invention are explained in detail hereafter by means of the description of the exemplary embodiments and the drawings, in which here

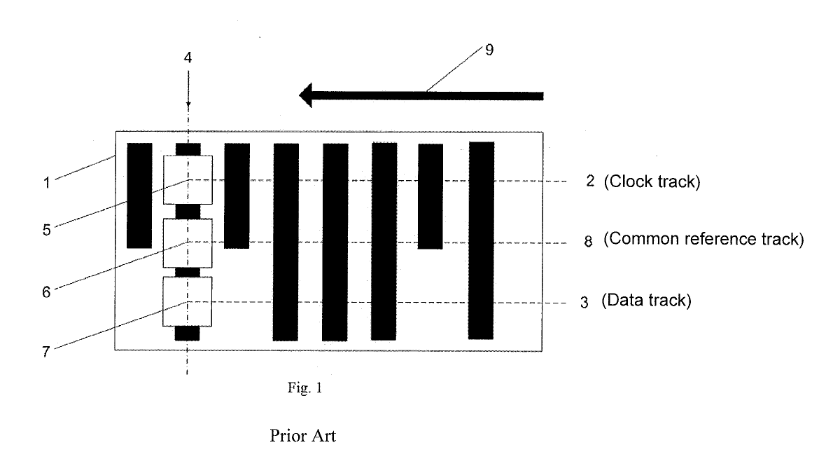

FIG. 1 shows a schematic representation of the data carrier with a reader unit according to the prior art,

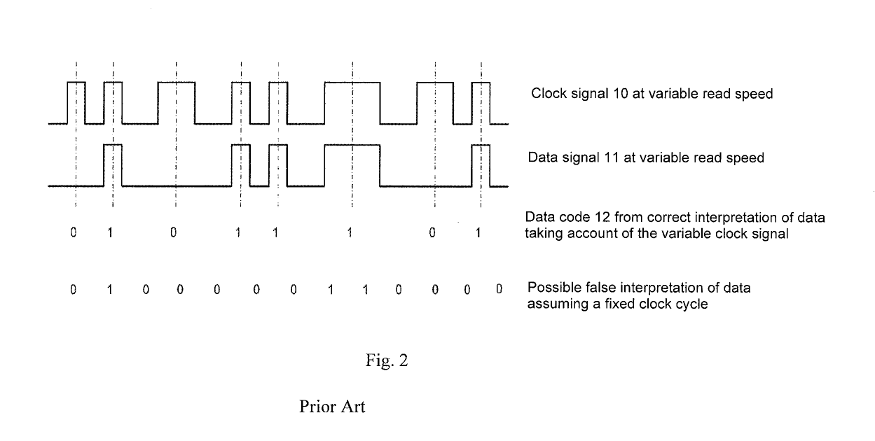

FIG. 2 shows the signal waveform of the information tracks read out together with the resulting data code for the data carrier according to FIG. 1,

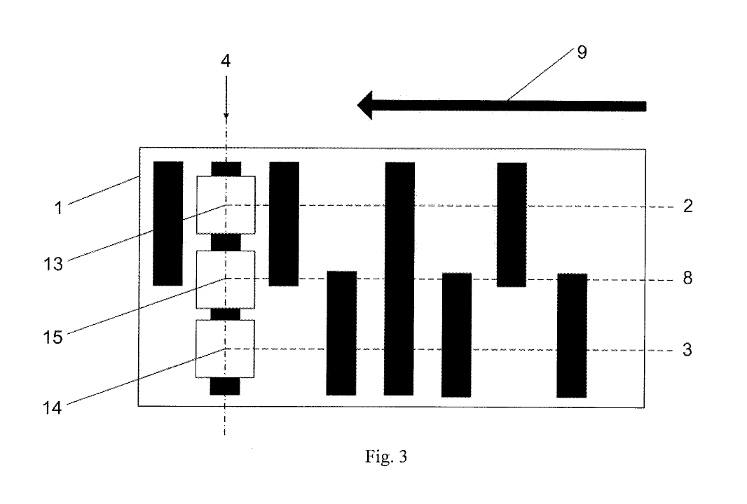

FIG. 3 shows a schematic representation of the data carrier with a reader unit according to a first exemplary embodiment,

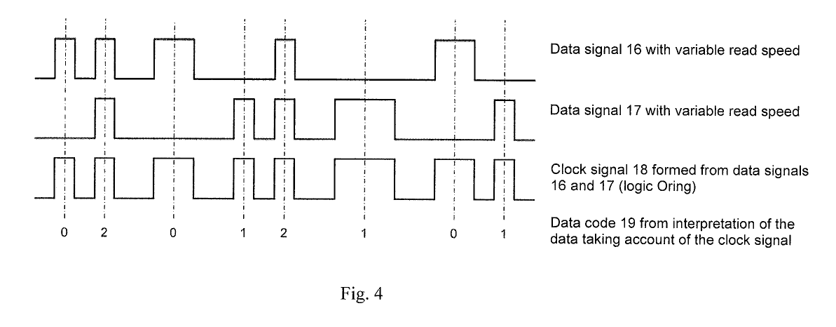

FIG. 4 shows the signal waveform of the information tracks read out together with the resulting data code for the exemplary embodiment according to FIG. 3,

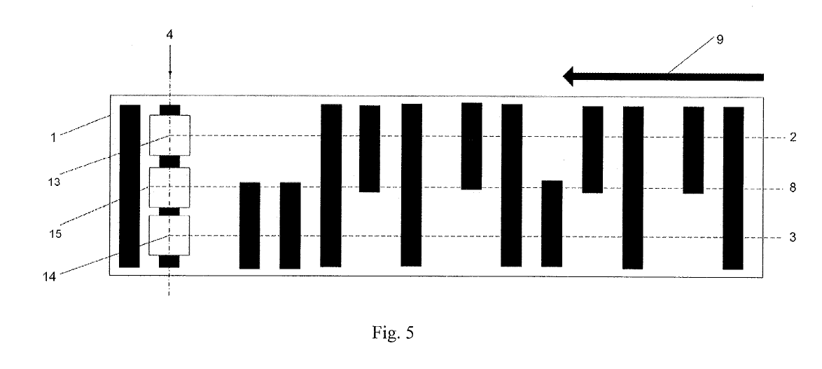

FIG. 5 shows a schematic representation of the data carrier with a reader unit according to a second exemplary embodiment,

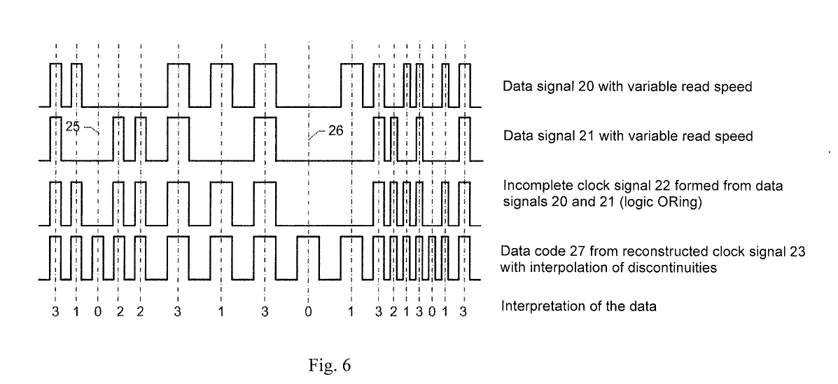

FIG. 6 shows the signal waveform of the information read out together with the resulting data code for the data carrier according to FIG. 5.

The prior art illustrated in FIG. 1 shows a data carrier 1 having two imprinted information tracks 2, 3 of electrically conductive material, the information track 2 forming a clock track and the information track 3 forming a data track. Furthermore, a reference track 8 is provided between the two information tracks. All the information tracks are in the form of a line sequence, the information track 3 being a binary code.

A reader unit 4 having a clock electrode 5, a middle electrode 6 and a data electrode 7 is provided for reading the data carrier. The electrodes are in this case arranged in such a way that they capture the information track 2 (clock track), the reference track 8 and the information track 3 (data track) respectively. Read-out can be effected, in particular, by way of a capacitive coupling.

The clock electrode 5 and the middle electrode 6 are used to read out the information track 2, whereas the data electrode 7 and the middle electrode 6 are used to read out the information track 3. During the reading operation, the data carrier 1 is inserted in the direction of arrow 9 into the reader unit 4.

At a variable read speed, the clock signal 10 and data signal 11 shown in FIG. 2, for example, are produced for the information tracks 2 and 3 respectively. The correct interpretation of the data signal taking account of the variable clock signal then produces the following binary data code 12: 0 1 0 1 1 1 0 1.

If merely the data signal 11 were available and assuming a fixed clock cycle, then the following false binary code would be obtained: 0 1 0 0 0 0 0 1 1 0 0 0 0.

In the case of the prior art described by means of FIGS. 1 and 2, clocking is direct. The clock recovery according to the invention from the data signal is described in detail in the following by means of two exemplary embodiments.

In the first exemplary embodiment according to FIG. 3, the data carrier 1 again has two information tracks 2, 3 as well as a reference track 8, which can be read out by a reader unit 4 by means of a first electrode 13, a second electrode 14 and a middle electrode 15.

Assuming again that the read speed is variable, the data signals 16, 17 shown in FIG. 4 are obtained for the two information tracks 2, 3. Provided that the “1” state is present at least once per clock cycle either in the first data signal 16 and/or in the second data signal 17, the clocking of the data can be reconstructed by logic ORing of the two data signals 16, 17. The resulting clock signal 18 is likewise illustrated in FIG. 4.

The result is that where there are two information tracks 2, 3, a total of three states can be distinguished (“01”, “10” and “11”). In contrast, in the case of a synchronous method with two information tracks, four states can be distinguished (“00”, “01”, “10” and “11”). As a generalisation, with n information tracks always 2ⁿ−1 states can be distinguished, without sacrificing the clock recovery. This means that during each clock cycle the presence of the “0” state simultaneously in both information tracks 2, 3 must be excluded.

The first exemplary embodiment can be expanded to the effect that also the simultaneous “0” state in the information tracks is allowed for the coding. As is apparent from FIGS. 5 and 6, data signals 20 and 21 can again be determined from the information tracks 2 and 3 respectively, and a clock signal 22 can be determined by logic ORing. Owing to the simultaneous presence of the “0” state in the two information tracks 2, 3, this clock signal 22 now has discontinuities 25, 26, which are supplemented by interpolation of the preceding and following clock pulses, resulting in a reconstructed clock signal 23.

The data code 27 can in turn be determined from the two data signals 20 and 21 and the reconstructed clock signal 23, and a total of four states can be distinguished.

Conductive polymers in particular, such as PEDOT or PANI, can be considered as electrically conductive material. If the electrically conductive material can be printed by means of a mass printing method, in particular by means of relief printing, intaglio printing or planographic printing, manufacture of the data carrier is especially cost-effective. Because the information tracks contain both a data signal and a clock signal, a reliable read-out of a printed data carrier can be ensured even at a variable read speed.

So that the interpolation according to the second exemplary embodiment can function, the information tracks must comply with specific requirements. Thus, the simultaneous “0” state may not occur arbitrarily often in succession in the information tracks, as otherwise the discontinuities in the incomplete clock signal 22 become too large to be capable of being supplemented by interpolation. This requirement must be taken into account as early as the stage of generating or individualising the printed information tracks.

Furthermore, in this method the maximum change in the read speed is limited. If the read speed alters too quickly, the true characteristic of the clocking may possibly not be reconstructed in the discontinuities. The stipulation of how often in succession the “0” state may occur must be established anew for each application of the method. It depends substantially on how quickly the read speed can change.

1. A method for storing and reading a data code, wherein a least two information tracks (2, 3) of electrically conductive material are printed onto a substrate in such a way that by parallel reading of the at least two information tracks a clock signal (10; 18; 23) and a data signal (11; 16, 17; 20, 21) are determined, by means of which the data code is formed,
characterised in that the clock signal (18, 22) is formed by logic ORing of the information tracks (2, 3) and the data code (19, 27) is determined by interpreting the information tracks (2, 3) taking account of the clock signal.

2. A method according to claim 1, characterised in that the at least two information tracks (2, 3) are constructed in such a way that during each clock cycle the presence of the “0” state simultaneously in both information tracks (2, 3) is excluded.

3. A method according to claim 1, characterised in that the clock signal (23) is determined by the logic ORing of the information tracks (2, 3) and interpolating any discontinuities.

4. A method according to claim 1, characterised in that a change in the read speed of the two information tracks (2, 3) is allowed.

5. A method according to claim 1, characterised in that conductive polymers, in particular PEDOT or PANI are used as the electrically conductive material.

6. A method according to claim 6, characterised in that the electrically conductive material is printed by means of a mass printing method, in particular by means of relief printing, intaglio printing or planographic printing.

7. A method according to claim 6, characterised in that the information tracks (2, 3) are formed by a binary code.

8. A data carrier (1) for storing a data code (13; 19; 27), having a least two information tracks (2, 3) of electrically conductive material printed onto a substrate, the information tracks containing both a data signal (11; 16, 17; 20, 21) and a clock signal (10; 18; 23),
characterised in that the clock signal (18, 22) is formed by logic ORing of the information tracks (2, 3) and the data code (19, 27) is determined by interpreting the information tracks (2, 3) taking account of the clock signal.

9. A data carrier according to claim 8, characterised in that the electrically conductive material comprises conductive polymers, in particular PEDOT or PANI.

10. A data carrier according to claim 8, characterised in that the information tracks (2, 3) are formed by a line sequence.
